(19) United States
(12) Patent Application Publication
(10) Pub. No.: US 2019/0221184 A1
(43) Pub. Date: Jul. 18, 2019

(54) DISPLAY DEVICE, DISPLAY CONTROL DEVICE, AND DISPLAY CONTROL METHOD

(71) Applicant: MITSUBISHI ELECTRIC CORPORATION, Tokyo (JP)

(72) Inventors: Hirohiko HIGUCHI, Tokyo (JP); Takeyuki AIKAWA, Tokyo (JP)

(73) Assignee: MITSUBISHI ELECTRIC CORPORATION, Tokyo (JP)

(21) Appl. No.: 16/312,923

(22) PCT Filed: Jul. 29, 2016
(86) PCT No.: PCT/JP2016/072317

§ 371 Date: Dec. 21, 2018

(51) Int. Cl. G09G 5/00; G06K 9/00; G02B 27/01

(52) U.S. Cl. CPC G09G 5/003; G06K 9/00671; G02B 27/0172; G09G 2340/12; G02B 2027/0138; G02B 2027/014; G09G 2340/045; G02B 2027/0178

(57) ABSTRACT

A display device includes: a transmissive display unit disposed in front of the eyes of a user; an image capturing unit for capturing a real world image at an image capturing view angle larger than a display view angle of the display unit; an AR recognizing unit for recognizing an object regarding which additional information is displayed from the captured real world image; a mode determining unit for determining whether a real object superimposing mode or an image superimposing mode is applied; and a display control unit for allowing additional information regarding the recognized object to be superimposed and displayed on the real world which has transmitted through the display unit in the real object superimposing mode, and allowing the additional information regarding the recognized object to be superimposed and displayed on the captured real world image in the image superimposing mode.

### TECHNICAL FIELD

The present invention relates to a display device using an augmented reality (AR) technique, a display control device for controlling display of the display device, and a display control method for controlling display of the display device.

### BACKGROUND ART

A glasses type display device (so-called smartglasses) includes a non-transmissive device in which a display is opaque and the real world cannot be seen, and a transmissive device in which a display is transparent and the real world and display information can be seen simultaneously. The transmissive glasses do not cover the field of view of a user and is therefore expected to be used in a place which is movable and where safety is emphasized. With the AR technique, additional information regarding a real object is displayed on the transmissive glass display, and therefore a user wearing the transmissive glasses sees the information as if the information were floating on the real object in front of his/her eyes.

The transmissive glasses are equipped with a camera, and a capturing range of a camera is a range of AR in which information can be added to the real world. In conventional transmissive glasses, since a display view angle of a display is narrower than a person's field of view and an image capturing view angle of a camera, display is made in such a form that a person peeps into a world to which information is added through box glasses, and it is difficult to grasp the whole image of the real world to which information is added. In order to grasp the whole image, it is necessary for a user to move the head frequently and to interpolate a relationship between the real world and the added information in the head.

For example, the invention according to Patent Literature 1 proposes a method for displaying an annotation indicating a direction of an object on a display in a case where an AR object exists outside a display view angle of the display. As a result, even when an object exists outside the display view angle, the direction of the object can be recognized.

### CITATION LIST

### Patent Literatures

Patent Literature 1: JP 2005-174021 A

### SUMMARY OF INVENTION

### Technical Problem

However, according to the invention of Patent Literature 1, it can be recognized that there is an object outside the display view angle of the display, but there is a problem in that the whole image of AR in a wider range than the display view angle cannot be grasped. That is, a sense of peeping into the world of AR through box glasses is relieved, but the problem has not been solved. Therefore, it is necessary for a user to be conscious of a positional relationship between objects in his/her mind. In a case where many objects exist outside the display view angle, many annotations are displayed on the display, and the field of view of a user is obstructed.

The present invention has been achieved in order to solve the above-mentioned problems, and an object of the present invention is to display all recognition objects located within an image capturing view angle of a camera even when the image capturing view angle of the camera is larger than a display view angle of a display and a person's field of view.

### Solution to Problem

A display device according to the present invention includes: a transmissive display unit disposed in front of eyes of a user; an image capturing unit for capturing a real world image with an image capturing view angle larger than a display view angle of the display unit; an AR recognizing unit for recognizing an object regarding which additional information is to be displayed from the real world image captured by the image capturing unit; a mode determining unit for determining whether a real object superimposing mode or an image superimposing mode is applied; and a display control unit for allowing additional information regarding the object recognized by the AR recognizing unit to be superimposed and displayed on real world which has transmitted through the display unit in a case of the real object superimposing mode, and allowing the additional information regarding the object recognized by the AR recognizing unit to be superimposed and displayed on the real world image captured by the image capturing unit in a case of the image superimposing mode.

### Advantageous Effects of Invention

According to the present invention, it is possible to switch between the real object superimposing mode in which additional information regarding an object is superimposed and displayed on the real world transmitted through the display unit and the image superimposing mode in which additional information regarding an object recognized by the AR recognizing unit is superimposed and displayed on the real world image captured by the image capturing unit, and therefore it is possible to display all recognition objects located within an image capturing view angle of the image capturing unit even when the image capturing view angle of the image capturing unit is larger than a display view angle of the display unit and a person's field of view. This makes it easier for a user to grasp a positional relationship among all recognition objects inside and outside the display view angle of the display unit, and makes it unnecessary for a user to search for a recognition object in the real object superimposing mode.

### BRIEF DESCRIPTION OF DRAWINGS

FIG. 1 is a block diagram illustrating a configuration example of a display device according to a first embodiment of the present invention.

FIGS. 2A and 2B are each a hardware configuration diagram illustrating a hardware configuration example of the display device according to the first embodiment.

FIG. 3 is a diagram for explaining a real object superimposing mode in the display device according to the first embodiment.

FIG. 4 is a diagram for explaining an image superimposing mode in the display device according to the first embodiment.

FIG. 5 is a flowchart illustrating operation of the display device according to the first embodiment.

FIG. 6A is a diagram for explaining operation of a range calculating unit in the display device according to the first embodiment, and FIGS. 6B, 6C, and 6D are diagrams for explaining an example of switching a mode.

FIGS. 7A and 7B each are a diagram for explaining inclination correction of a display control unit in the display device according to the first embodiment.

FIG. 8 is a diagram for explaining the real object superimposing mode in the display device according to the first embodiment, illustrating an example in which an image capturing view angle is wide.

FIG. 9 is a diagram for explaining the image superimposing mode in the display device according to the first embodiment, illustrating an example in which an image capturing view angle is wide.

### DESCRIPTION OF EMBODIMENTS

Hereinafter, in order to describe the present invention in more detail, an embodiment for carrying out the present invention will be described with reference to attached drawings.

### First Embodiment

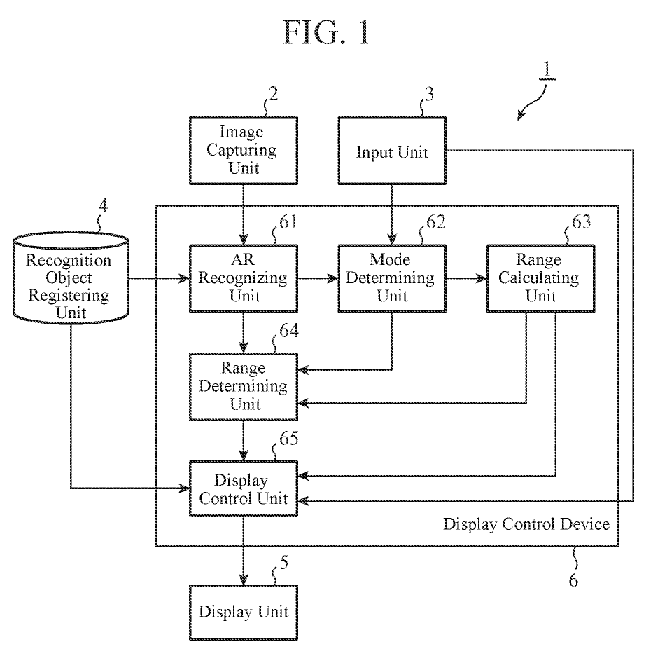

FIG. 1 is a block diagram illustrating a configuration example of a display device 1 according to a first embodiment of the present invention. Here, description will be given on the assumption that smartglasses are used as the display device 1. Note that the display device 1 only needs to be a wearable terminal that can be mounted on the body of a user, and is not limited to a glasses shape.

The display device 1 according to the first embodiment includes an image capturing unit 2, an input unit 3, a recognition object registering unit 4, a display unit 5, and a display control device 6. The display control device 6 includes an AR recognizing unit 61, a mode determining unit 62, a range calculating unit 63, a range determining unit 64, and a display control unit 65.

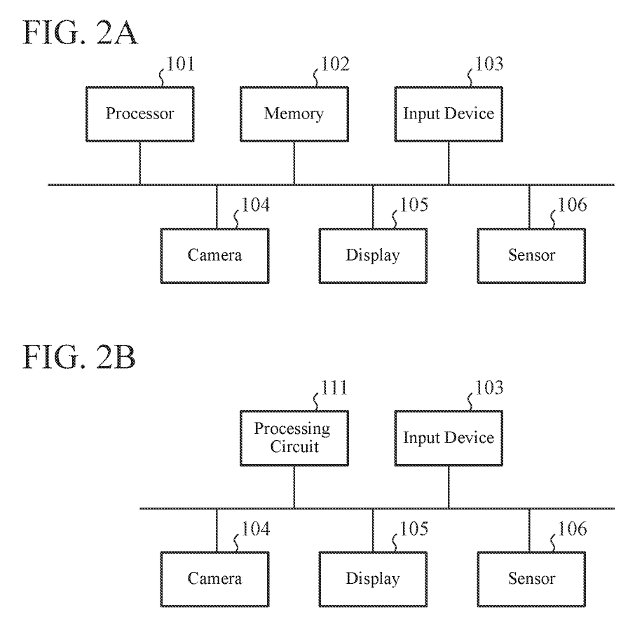

FIGS. 2A and 2B each are an example of a hardware configuration diagram of the display device 1 according to the first embodiment.

The image capturing unit 2 in the display device 1 is a camera 104. For example, the camera 104 is installed in a frame portion or the like of the smartglasses and captures a real world image from a position close to a viewpoint of a user.

The input unit 3 in the display device 1 is at least one of an input device 103 and a sensor 106. The input device 103 is a button installed in a frame portion or the like of the smartglasses and accepts a command input by pressing of the button by a user. Alternatively, the input device 103 is a combination of a microphone installed in the smartglasses or the like and a voice recognizing device using this microphone, and accepts a command input by the voice of a user.

The sensor 106 is, for example, an acceleration sensor or an inclination sensor installed in the smartglasses, and detects movement of the head of a user.

The display unit 5 in the display device 1 is a display 105. The display 105 is installed in a part or the whole portion of a lens of the smartglasses. When a user wears the smartglasses, the display 105 is disposed in front of the eyes. This display 105 is a transmissive display, and the user can see information displayed on the display 105 and the real world simultaneously.

The recognition object registering unit 4 in the display device 1 is a memory 102.

Note that the recognition object registering unit 4 and the following display control device 6 may be installed in the smartglasses or may be configured as devices separate from the smartglasses. In the case of the separate devices, the recognition object registering unit 4 and the display control device 6 which are separate devices can exchange information with the image capturing unit 2, the input unit 3, and the display unit 5 on the smartglasses by wireless communication or wired communication.

The display control device 6 in the display device 1 is a processor 101 for executing a program stored in the memory 102 as illustrated in FIG. 2A, or a processing circuit 111 that is dedicated hardware as illustrated in FIG. 2B.

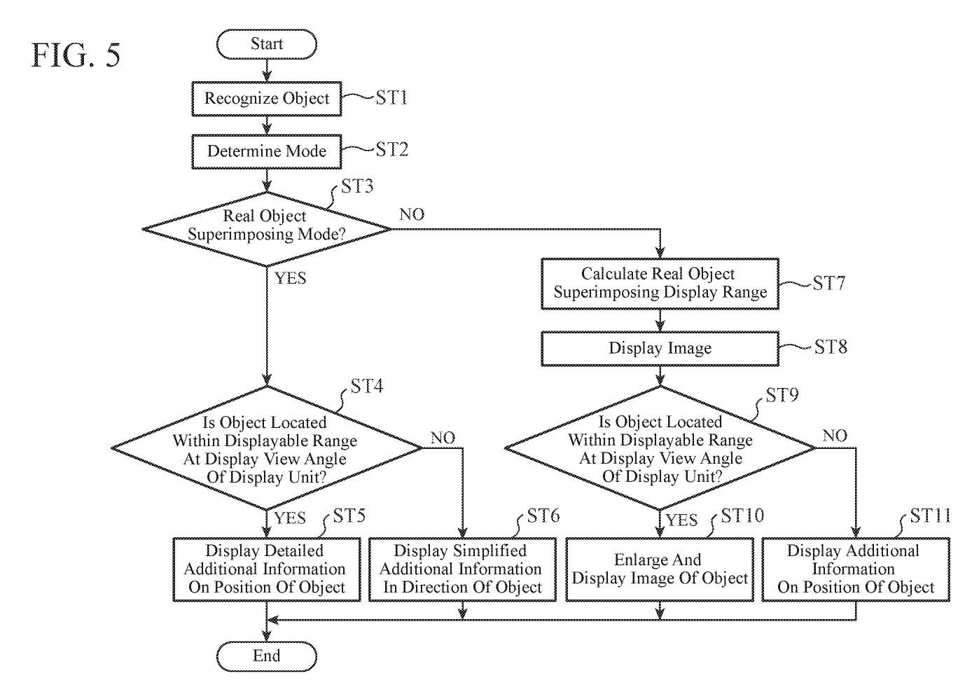

As illustrated in FIG. 2A, in a case where the display control device 6 is the processor 101, functions of the AR recognizing unit 61, the mode determining unit 62, the range calculating unit 63, the range determining unit 64, and the display control unit 65 are implemented by software, firmware, or a combination of the software and the firmware. The software or the firmware is described as a program and stored in the memory 102. The processor 101 reads and executes the program stored in the memory 102, and thereby implements the functions of the units. That is, the display control device 6 includes the memory 102 for storing a program that causes the step illustrated in FIG. 5 described later to be executed as a result when the program is executed by the processor 101. It can also be said that this program causes a computer to execute a procedure or a method of the display control device 6.

Here, the processor 101 is, for example, a central processing unit (CPU), a processing device, an arithmetic device, a microprocessor, a microcomputer, or a digital signal processor (DSP).

The memory 102 may be a nonvolatile or volatile semiconductor memory such as random access memory (RAM), read only memory (ROM), erasable programmable ROM (EPROM), flash memory, or solid state drive (SSD), may be a magnetic disk such as a hard disk or a flexible disk, or may be an optical disc such as a compact disc (CD) or a digital versatile disc (DVD).

As illustrated in FIG. 2B, in a case where the display device 1 is dedicated hardware, for example, a single circuit, a composite circuit, a programmed processor, a parallel programmed processor, an application-specific integrated circuit (ASIC), a field-programmable gate array (FPGA), or a combination thereof corresponds to the processing circuit 111. The functions of the units of the display control device 6 may be implemented by a plurality of processing circuits 111, or the functions of the units may be implemented collectively by a single processing circuit 111.

Note that some of the functions of the display control device 6 may be implemented by dedicated hardware, and some of the functions may be implemented by software or firmware. In this way, the display control device 6 in the display device 1 can be implemented by hardware, software, firmware, or a combination thereof.

Next, the real object superimposing mode and the image superimposing mode in the display device 1 according to the first embodiment will be described.

The real object superimposing mode is a mode in which additional information regarding a real object in the real world as a recognition object of AR is displayed on the display unit 5, and the additional information is thereby superimposed and displayed on the real world that has transmitted through the display unit 5. In the real object superimposing mode, a user can see the real world through the display unit 5.

The image superimposing mode is a mode in which an image capturing the real world is displayed on the display unit 5 and additional information regarding a recognition object is superimposed and displayed on the image. In the image superimposing mode, since the field of view of a user is covered by an image displayed on the display unit 5, the user cannot see the real world through the display unit 5.

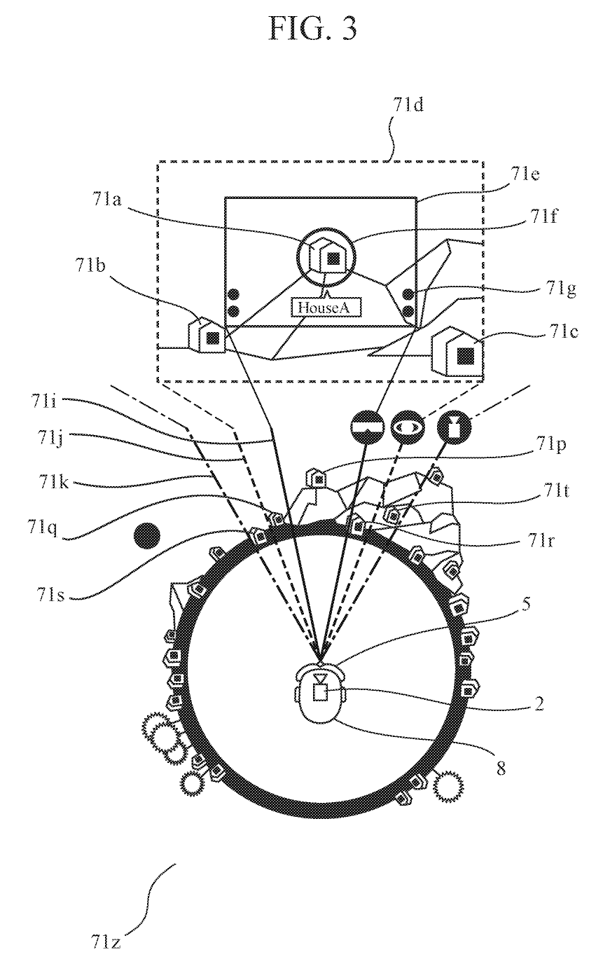

FIG. 3 is a diagram for explaining the real object superimposing mode.

A user 8 is wearing smartglasses as the display device 1. In FIG. 3, a real world 71z expresses the real world including an outside of a field of view 71j of the user 8. A field of view range 71d is a range which corresponds to the field of view 71j of the user 8 and which can be seen by the user 8 with the naked eyes. In FIG. 3, three houses are located within the field of view 71j of the user 8. Therefore, the user 8 sees houses 71p, 71q, and 71r in the real world 71z as houses 71a, 71b, and 71c in the field of view range 71d, respectively.

A display range 71e is a displayable range at a display view angle 71i of the display unit 5. In FIG. 3, one house is located within the display range 71e. That is, the house 71p in the real world 71z is located within the display range 71e as the house 71a.

An image capturing view angle 71k represents a view angle of the image capturing unit 2. In FIG. 3, five houses are located within the image capturing view angle 71k. That is, the image capturing unit 2 captures images of the houses 71p, 71q, 71r, 71s, and 71t in the real world 71z.

It is assumed that the five houses 71p, 71q, 71r, 71s, and 71t whose images are captured by the image capturing unit 2 are recognition objects of AR. Among these five houses, the house 71p is located within the display view angle 71i, and additional information 71f regarding the house 71a corresponding to the house 71p in the real world 71z is displayed in the display range 71e. The additional information 71f includes, for example, a circle surrounding the house 71a and a name “House A” of the house 71a. Meanwhile, as for the four houses 71q, 71r, 71s, and 71t not located within the display view angle 71i, four pieces of simplified additional information 71g are displayed in the display range 71e. The additional information 71g is a more simplified symbol than the additional information 71f and is displayed at positions indicating directions of the houses 71q, 71r, 71s, and 71t in the real world 71z in the display range 71e. In the example of FIG. 3, two pieces of simplified additional information 71g are displayed at a left end of the display range 71e, and two pieces of simplified additional information 71g are displayed at a right end of the display range 71e. It is expressed that two recognition objects exist on the left side of the user 8 and that two recognition objects exist on the right side of the user 8.

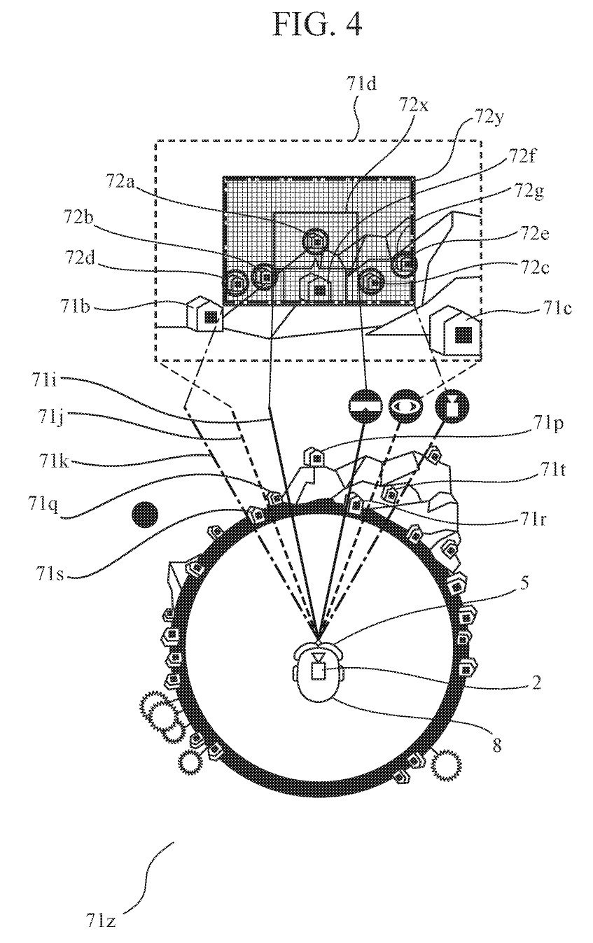

FIG. 4 is a diagram for explaining the image superimposing mode.

The configuration of the real world 71z is similar to that of FIG. 3.

An image range 72y is a range of an image of the image capturing unit 2 displayed on the display unit 5. In FIG. 4, the five houses 71p, 71q, 71r, 71s, and 71t in the real world 71z are displayed as houses 72a, 72b, 72c, 72d, and 72e in the image range 72y.

A display range 72x is a displayable range at the display view angle 71i of the display unit 5 and corresponds to the display range 71e of the real object superimposing mode. Since the image capturing view angle 71k of the image capturing unit 2 is wider than the display view angle 71i of the display unit 5, the display range 72x is included in the image range 72y.

When the mode of the display device 1 is switched from the image superimposing mode to the real object superimposing mode, the display range 72x of the image superimposing mode becomes equal to the display range 71e of the real object superimposing mode.

Note that the display unit 5 may display a frame corresponding to the display range 72x. The shape of this frame only needs to be a shape corresponding to the shape of the display range 72x, and is a rectangular frame in FIG. 4.

As in the real object superimposing mode, the five houses 71p, 71q, 71r, 71s, and 71t whose images are captured by the image capturing unit 2 are recognition objects of AR also in the image superimposing mode. In the image superimposing mode, additional information 72g regarding these five houses 72a, 72b, 72c, 72d, and 72e is displayed in the image range 72y. The additional information 72g is, for example, a circle surrounding a house. Furthermore, for the house 72a closest to the center in the display range 72x that is a displayable range at the display view angle 71i of the display unit 5, additional information 72f obtained by enlarging an image of the house 72a is displayed.

Next, operation of the display device 1 will be described with reference to a flowchart of FIG. 5.

In step ST1, the AR recognizing unit 61 recognizes an object regarding which additional information is displayed from a real world image captured by the image capturing unit 2. Specifically, using information registered in the recognition object registering unit 4, the AR recognizing unit 61 recognizes an object coinciding with the information from the image captured by the image capturing unit 2. Since it is only required to recognize an object using a known technique, description thereof will be omitted.

In the example of FIG. 3, information for recognizing a house is registered in the recognition object registering unit 4, and the AR recognizing unit 61 recognizes the five houses 71p, 71q, 71r, 71s, and 71t located within the image capturing view angle 71k of the image capturing unit 2 using the information.

The AR recognizing unit 61 outputs information regarding the recognized object to the mode determining unit 62 and the range determining unit 64. The image captured by the image capturing unit 2 is input to the display control unit 65 via the AR recognizing unit 61 and the range determining unit 64.

In step ST2, the mode determining unit 62 determines whether the real object superimposing mode or the image superimposing mode is applied. The mode determining unit 62 outputs the mode determination result to the range calculating unit 63 and the range determining unit 64. In addition, the mode determining unit 62 outputs information regarding the object recognized by the AR recognizing unit 61 to the range calculating unit 63.

A mode is determined, for example, by a signal from the input unit 3. The mode determining unit 62 calculates movement of a head using a signal of the sensor 106 such as an acceleration sensor or an inclination sensor. In a case where the mode determining unit 62 estimates that a user is searching for something on the basis of the calculated movement of the head, the mode determining unit 62 determines that the image superimposing mode is applied. Meanwhile, in a case where the mode determining unit 62 estimates that a user is gazing at something on the basis of the calculated movement of the head, the mode determining unit 62 determines that the real object superimposing mode is applied. Alternatively, the mode determining unit 62 may switch the mode by using a signal from the input device 103, such as a command input by voice recognition or a command input by press of a button.

Alternatively, the mode may be determined by the information regarding the object recognized by the AR recognizing unit 61. In a case where an object exists within the display range 72x that is a displayable range at a display view angle of the display unit 5 or in a case where nothing can be recognized by the AR recognizing unit 61, the mode determining unit 62 determines that the real object superimposing mode is applied. In a case where the AR recognizing unit 61 recognizes at least one object and the object exists outside the display range 72x that is a displayable range at a display view angle of the display unit 5, the mode determining unit 62 determines that the image superimposing mode is applied.

In step ST3, the display control device 6 proceeds to step ST4 if it is determined that the real object superimposing mode is applied (“YES” in step ST3), and the display control device 6 proceeds to step ST7 If it is determined that the image superimposing mode is applied (“NO” in step ST3). In steps ST4 to ST6, as the real object superimposing mode, as illustrated in FIG. 3, the additional information regarding the object recognized by the AR recognizing unit 61 is superimposed and displayed on the real world that has transmitted through the display unit 5. On the other hand, in steps ST7 to ST11, as the image superimposing mode, as illustrated in FIG. 4, the additional information regarding the object recognized by the AR recognizing unit 61 is superimposed and displayed on a real world image captured by the image capturing unit 2.

In the following, as a more detailed example of the real object superimposing mode in steps ST4 to ST6 and the image superimposing mode in steps ST7 to ST11, operation of changing a display mode of additional information depending on the position of a recognized object will be described.

In step ST4, the range determining unit 64 determines whether or not the object recognized by the AR recognizing unit 61 is located within a displayable range at a display view angle of the display unit 5. The range determining unit 64 performs this determination for each object and outputs the determination result to the display control unit 65.

In a case of the real object superimposing mode, on the basis of the determination result of the range determining unit 64, the display control unit 65 changes a display mode of additional information regarding an object depending on whether or not the object is located within a displayable range at a display view angle of the display unit 5. Specifically, on the basis of the determination result of the range determining unit 64, the display control unit 65 performs the processing in step ST5 for an object located within a displayable range at a display view angle of the display unit 5 (“YES” in step ST4). Meanwhile, the display control unit 65 performs the processing in step ST6 for an object not located within a displayable range at a display view angle of the display unit 5 (“NO” in step ST4).

In step ST5, the display control unit 65 controls display of the display unit 5 so as to cause the display unit 5 to display detailed additional information regarding an object located within a displayable range at a display view angle of the display unit 5.

In the example of FIG. 3, for the house 71a located within the display range 71e that can be displayed at the display view angle 71i of the display unit 5, a circle and the name of the house in a balloon are displayed as the detailed additional information 71f.

In step ST6, the display control unit 65 controls display of the display unit 5 so as to cause the display unit 5 to display simplified additional information for an object not located within a displayable range at a display view angle of the display unit 5.

In the example of FIG. 3, circle symbols are displayed as the simplified additional information 71g in directions of the houses 71q, 71r, 71s, and 71t located outside the display range 71e that is a displayable range at the display view angle 71i of the display unit 5.

Note that the additional information 71f and 71g in the real object superimposing mode is not limited to the information illustrated in FIG. 3, and may be any information as long as being information regarding a recognition object. The display control unit 65 generates the additional information 71f and 71g, for example, using information registered in the recognition object registering unit 4.

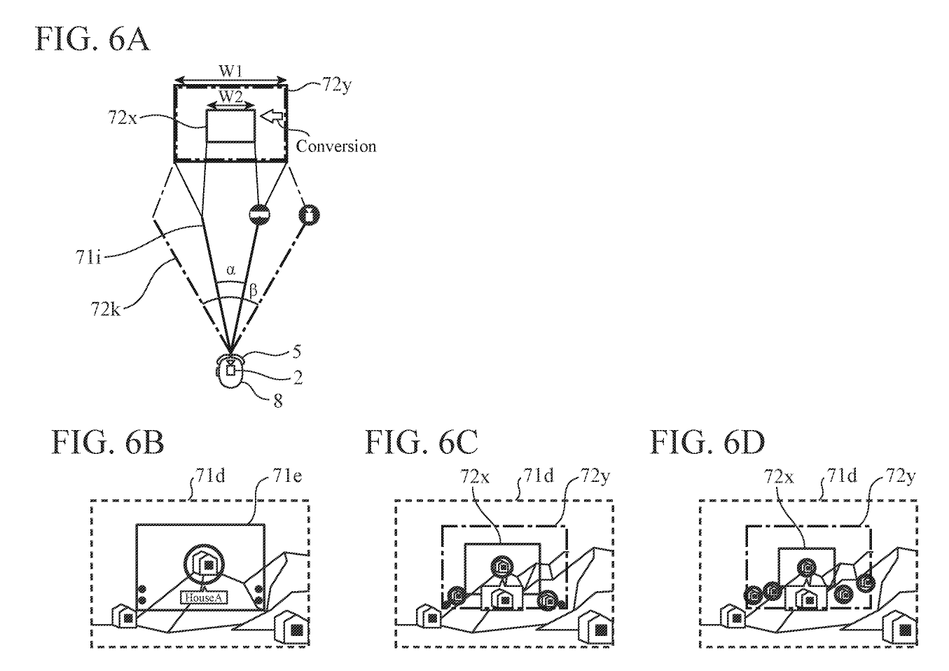

In step ST7, the mode determining unit 62 notifies the range calculating unit 63 that the image superimposing mode is applied. The range calculating unit 63 calculates a displayable range at a display view angle of the display unit 5 in the image superimposing mode. Specifically, the range calculating unit 63 calculates a displayable range W2 at a display view angle of the display unit 5 using the following formula (1). FIG. 6A is a diagram for explaining operation of the range calculating unit 63.

The range calculating unit 63 outputs information regarding a displayable range at a display view angle of the display unit 5, calculated using formula (1), to the range determining unit 64 and the display control unit 65.

W2=α/β×W1 (1)

Here, W1 is the image range 72y whose image can be captured at an image capturing view angle β of the image capturing unit 2, and W2 is the display range 72x that is a displayable range at a display view angle α of the display unit 5. W2, that is, a landscape located within the display range 72x in the image superimposing mode illustrated in FIG. 4 is the same as a landscape located within the display range 71e in the real object superimposing mode illustrated in FIG. 3.

Incidentally, in a case where a value of W2 is registered in advance in the range determining unit 64, the display control device 6 does not need to include the range calculating unit 63, and the processing in step ST7 is also skipped.

In step ST8, the display control unit 65 causes the display unit 5 to display a real world image captured by the image capturing unit 2. Note that the display control unit 65 may cause the display unit 5 to display an image obtained by superimposing a rectangular frame corresponding to the display range 72x on the real world image captured by the image capturing unit 2. By displaying the rectangular frame corresponding to the display range 72x that is a displayable range at a display view angle of the display unit 5, a range that can be seen in the real object superimposing mode becomes clear before switching is performed from the image superimposing mode to the real object superimposing mode.

At this time, when switching is performed between the real object superimposing mode and the image superimposing mode, the display control unit 65 may zoom out or zoom in an image to be displayed on the display unit 5 in the image superimposing mode to cause the image to correspond to a displayable range at a display view angle of the display unit 5 in the real object superimposing mode. An example of this operation will be described with reference to FIGS. 6B, 6C, and 6D. FIG. 6B illustrates operation in the real object superimposing mode, FIG. 6C illustrates operation while switching is performed between the real object superimposing mode and the image superimposing mode, and FIG. 6D illustrates operation in the image superimposing mode.

Specifically, when switching is performed from the real object superimposing mode to the image superimposing mode, first, the display control unit 65 causes the display unit 5 to display an image in a displayable range at a display view angle of the display unit 5 in the real world image captured by the image capturing unit 2 using the information regarding a range from the range calculating unit 63. Subsequently, the display control unit 65 gradually zoom outs the image being displayed, and finally causes the display unit 5 to display the whole real world image captured by the image capturing unit 2. As a result, switching is smoothly performed from the real object superimposing mode to the image superimposing mode, and a positional relationship among recognition objects inside and outside a display view angle of the display unit 5 can be easily grasped.

Conversely, when switching is performed from the image superimposing mode to the real object superimposing mode, the display control unit 65 performs control to erase the real world image being displayed on the display unit 5. At that time, the display control unit 65 gradually zooms in the real world image being displayed on the display unit 5 using the information regarding a range from the range calculating unit 63. Then, the display control unit 65 finally causes the display unit 5 to display an image in a displayable range at a display view angle of the display unit 5 in the real world image captured by the image capturing unit 2, and then erases the image. As a result, after switching is performed from the image superimposing mode to the real object superimposing mode, the object at which the user 8 is gazing smoothly changes to a real object.

In step ST9, the range determining unit 64 determines whether or not the object recognized by the AR recognizing unit 61 is located within a displayable range at a display view angle of the display unit 5. The range determining unit 64 performs this determination for each object and outputs the determination result to the display control unit 65.

As in the real object superimposing mode, also in a case of the image superimposing mode, on the basis of the determination result of the range determining unit 64, the display control unit 65 changes a display mode of additional information regarding an object depending on whether or not the object is located within a displayable range at a display view angle of the display unit 5. Specifically, on the basis of the determination result of the range determining unit 64, the display control unit 65 performs the processing in step ST10 for an object located within a displayable range at a display view angle of the display unit 5 (“YES” in step ST9). Meanwhile, the display control unit 65 performs the processing in step ST11 for an object not located within a displayable range at a display view angle of the display unit 5 (“NO” in step ST9).

In step ST10, the display control unit 65 controls display of the display unit 5 so as to cause the display unit 5 to display additional information obtained by extracting and enlarging an image of an object closest to the center of a displayable range at a display view angle of the display unit 5 among objects located within the range.

In the example of FIG. 4, for the house 72a closest to the center of the display range 72x that is a displayable range at the display view angle 71i of the display unit 5, a balloon obtained by enlarging an image of the house 72a is displayed as the additional information 72f.

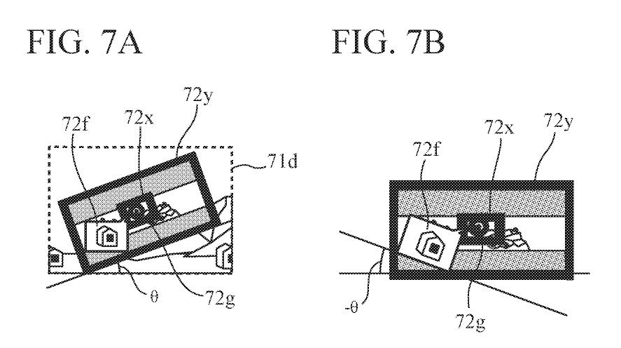

Note that the display control unit 65 may perform inclination correction when allowing the additional information 72f in a balloon shape to be displayed in step ST10. FIGS. 7A and 7B illustrate diagrams for explaining inclination correction of the display control unit 65. The display control unit 65 calculates an inclination angle θ of the head of the user 8 on the basis of a signal from the sensor 106 which is the input unit 3. Then, by cutting out an object image from the real world image captured by the image capturing unit 2, generating the balloon-shaped additional information 72f, and rotating the additional information 72f by an angle −θ, the display control unit 65 performs inclination correction and causes the display unit 5 to display the corrected result. The inclination angle of the object in the balloon is in agreement with the inclination angle of the object in the real world, and after switching is performed from the image superimposing mode to the real object superimposing mode, the object at which the user 8 is gazing smoothly changes to a real object.

In step ST11, the display control unit 65 controls display of the display unit 5 so as to cause the display unit 5 to display additional information for an object not located within a displayable range at a display view angle of the display unit 5.

In the example of FIG. 4, for the houses 72b, 72c, 72d, and 72e located outside the display range 72x that is a displayable range at the display view angle 71i of the display unit 5, circles surrounding these houses are displayed as the additional information 72g. Incidentally, in the example of FIG. 4, a circle is displayed as the additional information 72g also for the house 72a located within the display range 72x.

Note that the additional information 72f and 72g in the image superimposing mode is not limited to the information illustrated in FIG. 4, and may be any information as long as being information regarding a recognition object. The display control unit 65 generates the additional information 72f and 72g, for example, using information registered in the recognition object registering unit 4.

As described above, the display device 1 according to the first embodiment includes: the transmissive display unit 5 disposed in front of the eyes of a user; the image capturing unit 2 for capturing a real world image at an image capturing view angle larger than a display view angle of the display unit 5; the AR recognizing unit 61 for recognizing an object regarding which additional information is to be displayed from the real world image captured by the image capturing unit 2; the mode determining unit 62 for determining whether a real object superimposing mode or an image superimposing mode is applied; and the display control unit 65 for allowing additional information regarding the object recognized by the AR recognizing unit 61 to be superimposed and displayed on the real world which has transmitted through the display unit 5 in a case of the real object superimposing mode, and allowing the additional information regarding the object recognized by the AR recognizing unit 61 to be superimposed and displayed on the real world image captured by the image capturing unit 2 in a case of the image superimposing mode. With this configuration, even when the image capturing view angle of the image capturing unit 2 is larger than a display view angle of the display unit 5 and a user's field of view, by switching between the real object superimposing mode and the image superimposing mode, it is possible to display all recognition objects located within an image capturing view angle of the image capturing unit 2. As a result, a user can easily grasp a positional relationship among all recognition objects inside and outside the display view angle of the display unit 5, and does not need to search for a recognition object in the real object superimposing mode.

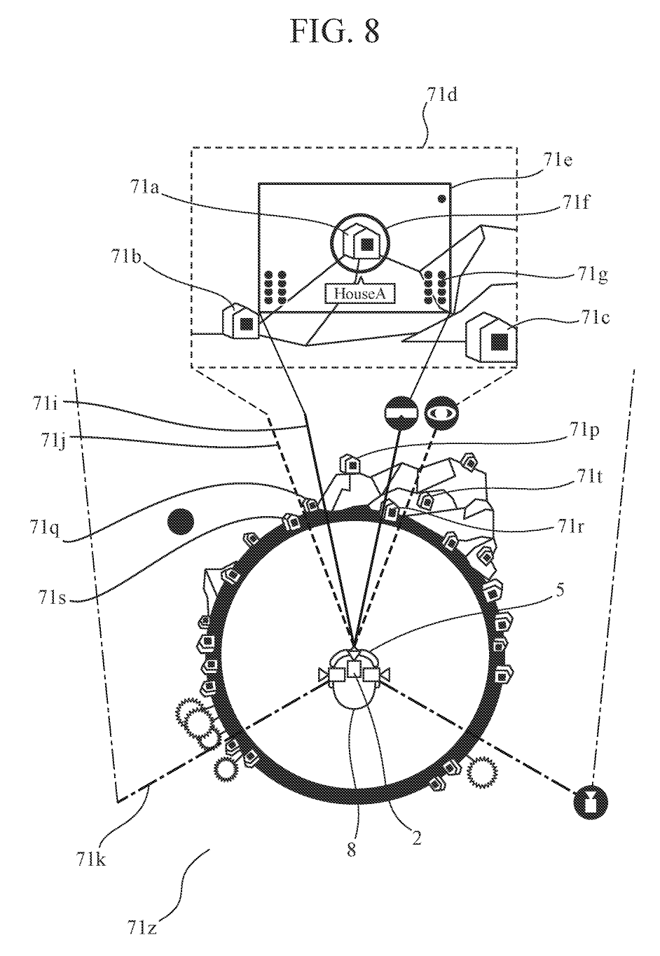

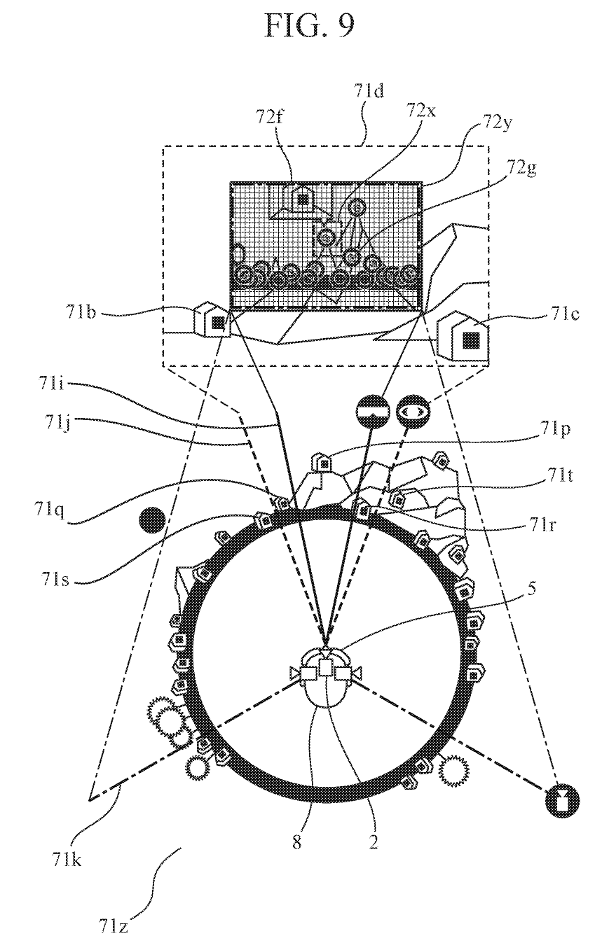

In the above description, the configuration using one camera as the image capturing unit 2 has been described, but a configuration using a plurality of cameras as the image capturing unit 2 may be used. Here, FIG. 8 is a diagram for explaining the real object superimposing mode in a case where three cameras are used as the image capturing unit 2. FIG. 9 is a diagram for explaining the image superimposing mode in a case where three cameras are used as the image capturing unit 2. By using a plurality of cameras, the image capturing view angle 71k is expanded, and more objects can be recognized. Therefore, in the real object superimposing mode, the display number of pieces of the additional information 71g indicating existence of a recognition object outside a display view angle is larger in FIG. 8 than in FIG. 3. In the image superimposing mode, the number of recognition objects to which the additional information 72g is given is larger in FIG. 9 than in FIG. 4. As described above, even in a case where the image capturing view angle of the image capturing unit 2 is extremely wider than the display view angle of the display unit 5, by using the display control method according to the first embodiment, a real object can be easily confirmed while the whole image is captured.

The display control unit 65 in the display device 1 according to the first embodiment changes a display mode of additional information depending on whether or not the object recognized by the AR recognizing unit 61 is located within a displayable range at a display view angle of the display unit 5 in the real object superimposing mode and the image superimposing mode. With this configuration, it is possible to display a recognition object within the display view angle of the display unit 5 and a recognition object outside the display view angle separately.

Incidentally, in the first embodiment, the display mode of the additional information is changed in both the real object superimposing mode and the image superimposing mode, but the display mode of the additional information may be changed only in either the real object superimposing mode or the image superimposing mode.

When switching is performed between the real object superimposing mode and the image superimposing mode, the display control unit 65 in the display device 1 according to the first embodiment zooms out or zooms in an image to be displayed on the display unit 5 in the image superimposing mode to cause the image to correspond to a displayable range at a display view angle of the display unit 5 in the real object superimposing mode. With this configuration, switching is smoothly performed between the real object superimposing mode and the image superimposing mode, and a user does not need to search for a recognition object at the time of mode switching.

In addition, in a case of the image superimposing mode, the display control unit 65 in the display device 1 according to the first embodiment extracts an image of an object closest to the center within a displayable range at a display view angle of the display unit 5 from the real world image captured by the image capturing unit 2, and enlarges and displays the image. With this configuration, even in a case where the object displayed on the display unit 5 is small and difficult to see, a real object can be easily confirmed.

In addition, in a case of the image superimposing mode, the display control unit 65 in the display device 1 according to the first embodiment allows a frame corresponding to a displayable range at a display view angle of the display unit 5 to be superimposed and displayed on the real world image captured by the image capturing unit 2. With this configuration, a range that can be seen in the real object superimposing mode becomes clear before switching is performed from the image superimposing mode to the real object superimposing mode.

Note that any component in the embodiment can be modified, or any component in the embodiment can be omitted within the scope of the present invention.

### INDUSTRIAL APPLICABILITY

In the display device according to the present invention, all recognition objects of AR captured by a camera are displayed on a display, and therefore is suitable for use as a display device such as smartglasses.

### REFERENCE SIGNS LIST

1: Display device, 2: Image capturing unit, 3: Input unit, 4: Recognition object registering unit, 5: Display unit, 6: Display control device, 8: User, 61: AR recognizing unit, 62: Mode determining unit, 63: Range calculating unit, 64: Range determining unit, 65: Display control unit, 71a to 71c, 71p to 71t, 72a to 72e: House, 71d: Field of view range, 71e, 72x: Display range, 71f, 71g, 72f, 72g: Additional information, 71i: Display view angle, 71j: Field of view, 71k: Image capturing view angle, 71z: Real world, 72y: Image range, 101: Processor, 102: Memory, 103: Input device, 104: Camera, 105: Display, 106: Sensor, 111: Processing circuit.

1. A display device comprising:
a transmissive display disposed in front of eyes of a user;
a processor; and
a memory storing instructions which, when executed by the processor, causes the processor to perform processes of:
capturing a real world image with an image capturing view angle larger than a display view angle of the display;
recognizing an object regarding which additional information is to be displayed from the captured real world image;
determining whether a real object superimposing mode or an image superimposing mode is applied; and
allowing additional information regarding the recognized object to be superimposed and displayed on real world which has transmitted through the display in a case of the real object superimposing mode, and allowing the additional information regarding the recognized object to be superimposed and displayed on the captured real world image in a case of the image superimposing mode.

2. The display device according to claim 1, wherein
the processor changes a display mode of additional information depending on whether or not the recognized object is located within a displayable range at the display view angle of the display in at least one of the real object superimposing mode and the image superimposing mode.

3. The display device according to claim 1, wherein when switching is performed between the real object superimposing mode and the image superimposing mode, the processor zooms out or zooms in an image to be displayed on the display in the image superimposing mode to cause the image to correspond to a displayable range at the display view angle of the display in the real object superimposing mode.

4. The display device according to claim 1, wherein in a case of the image superimposing mode, the processor extracts an image of an object closest to a center within a displayable range at the display view angle of the display from the captured real world image, and enlarges and displays the image.

5. The display device according to claim 1, wherein in a case of the image superimposing mode, the processor allows a frame corresponding to a displayable range at the display view angle of the display to be superimposed and displayed on the captured real world image.

6. A display control device for controlling display of a display device including a transmissive display disposed in front of eyes of a user and an image capturer to capture a real world image, comprising:
a processor; and
a memory storing instructions which, when executed by the processor, causes the processor to perform processes of:
recognizing an object regarding which additional information is to be displayed from the real world image captured by the image capturer;
determining whether a real object superimposing mode or an image superimposing mode is applied; and
allowing additional information regarding the recognized object to be superimposed and displayed on real world which has transmitted through the display in a case of the real object superimposing mode, and allowing the additional information regarding the recognized object to be superimposed and displayed on the real world image captured by the image capturer in a case of the image superimposing mode.

7. A display control method for controlling display of a display device including a transmissive display disposed in front of eyes of a user and an image capturer to capture a real world image, comprising:
recognizing an object regarding which additional information is to be displayed from the real world image captured by the image capturer;
determining whether a real object superimposing mode or an image superimposing mode is applied; and
allowing additional information regarding the recognized object to be superimposed and displayed on real world which has transmitted through the display in a case of the real object superimposing mode, and allowing the additional information regarding the recognized object to be superimposed and displayed on the real world image captured by the image capturer in a case of the image superimposing mode.
